(19) United States
(12) Patent Application Publication
(10) Pub. No.: US 2023/0228698 A1
(43) Pub. Date: Jul. 20, 2023

(54) SYSTEMS AND METHODS FOR DETERMINING THE MOISTURE LEVEL IN PLASTICS AND OTHER MATERIALS

(71) Applicant: Prophecy Sensorlytics, LLC, Baltimore, MD (US)

(72) Inventor: Biplab PAL, Ellicott City, MD (US)

(73) Assignee: Prophecy Sensorlytics, LLC, Baltimore, MD (US)

(21) Appl. No.: 17/568,177

(22) Filed: Jan. 4, 2022

(51) Int. Cl. G01N 27/22

(52) U.S. Cl. CPC G01N 27/223

(57) ABSTRACT

Systems for determining the moisture level in non-polar materials, such as polymers, include an electrical circuit including a capacitive sensor, and a signal generator that the provides the electrical circuit with an electrical input of varying frequency. The systems also include a computing device the determines the moisture level in the non-polar material based on a relationship between the moisture level, and a response of the electrical circuit to the electrical input while the capacitive sensor is in contact with the non-polar material.

### BACKGROUND

Many industrial processes require precise control of the bulk moisture level in solid materials, often to ppm levels. Precise moisture-level control is needed, for example, to meet quality requirements and regulatory standards, and to avoid defects in the end products manufactured from the solid materials. In various sectors, such as medicine, food, agrochemicals, plastics, construction, mining, paper manufacturing, catalyst manufacturing, petrochemicals, semiconductors, etc., determining and controlling the moisture content of natural and manufactured materials can be critical. And in some situations, the moisture concentration of a product is used to determine its quality.

Bulk moisture detection is a major challenge in the drying industry. For example, the process of drying a polymeric material can use enormous amounts of energy, as the polymeric materials are dried based on pre-estimated timing and without knowing bulk moisture contents of the incoming materials, which in turn may lead to more energy consumption as well as low product quality.

Direct and indirect techniques, which can be online or offline measurements, commonly are used to determine the moisture concentration of bulk materials. Direct techniques include oven drying while monitoring the resulting weight loss in the product, and chemical titration with Karl Fischer reagents. Indirect moisture detection techniques include electromagnetic wave measurement; nuclear, dielectric, and infrared sensors; etc. In each of these techniques, however, the measurement system has to be calibrated for use with the material, and specifically for low ppm level bulk-moisture measurement of low moisture content, where the dielectric is contributed mostly by the material and not by the water molecules in the material. This can lead to substantial difficulties, as it is not feasible, from a practical standpoint, to calibrate the system for use with all possible batches of polymers with different compositions.

### SUMMARY

The dielectric properties of non-polar materials, which include polymers such as polyesters, polystyrene, etc., do not change significantly when such materials are subject to a voltage whose frequency is varied within the radiofrequency range. The dielectric properties of moisture, however, change significantly with the frequency of the input voltage. (Pawlikowski, G.T. Effects of Polymer Material Variations On High Frequency Dielectric Properties. MRS Online Proceedings Library 1156, 205 (2008), https://doi.org/10.1557/PROC-1156-D02-05.)

For example, FIG. 1A depicts the variation in the real part of the dielectric constant (Dk) of a polyamide material with variations in the input-voltage frequency, for three different moisture levels in the material. As can be seen in FIG. 1A, the variation in Dk is affected substantially by the presence of moisture in the material. FIG. 1B shows that the loss tangent (tan δ) likewise is affected by the moisture level in the polyamide material. (The loss tangent is the real part of the dielectric, and is indicative of the degree of absorption of the EM wave.) Thus, when measuring the capacitance of a moisture-bearing polymeric material while subjecting the material to a voltage of varying frequency, the dielectric contributed by the polymeric material can be eliminated by determining the slope, or change in the capacitance in relation to the frequency of the input voltage. The measured change in capacitance, therefore, solely will reflect the amount of moisture in the polymer, and can be correlated with the moisture level determined independently using conventional measurement techniques. Once the correlation is established, it can be used subsequently to determine the moisture level in polymers without the need for any additional correlation or calibration, regardless of the type of polymer.

In the disclosed moisture measurement systems, a capacitance probe or sensor is configured to be immersed in raw plastic pellets undergoing a drying process, so that some of the pellets become disposed between the plates of the capacitance probe. A radiofrequency (RF) generator provides an input voltage to the capacitance probe, and the input voltage is varied within the radiofrequency range. A capacitance-measuring circuit scans the real part of the dielectric response of the capacitance probe to the varying input voltage.

Typically, the dielectric value of the moisture present in the plastic pellets decreases with the frequency of the input voltage. Because the dielectric value of the plastic pellets themselves is not affected significantly by the varying input voltage, the characteristics of the decreasing curve of input-voltage frequency vs. capacitance can be used as a quantifiable pattern indicating the level of bulk moisture in the plastic pellets. Thus, there is no need to eliminate, by calibration, the contribution of the polymeric material to the measured capacitance of the capacitance probe immersed in the plastic pellets. Such a calibration, were it to be required, would be a highly time-consuming and often impractical task.

In the disclosed embodiments, because the dielectric contributed by the polymeric materials has been eliminated by using the differential of the dielectric response at high and low RF frequencies (which eliminates the dielectric contribution from the material), low bulk moisture concentration in the plastic pellets can be detected quickly, and there is no need to recalibrate the moisture measurement system whenever the type of polymer undergoing the moisture measurement is changed. Applicants have found that bulk moisture concentration can be measured very precisely using the above technique, with measurement accuracies similar to those of the direct measurement of the Karl Fischer method. Obviating the need to calibrate a moisture sensing system for each different type of polymeric material with which the system is used can provide a substantial advantage in the drying industry, where hundreds of different types of polymers typically require drying prior to being processed.

In one aspect of the disclosed technology, a system for determining the moisture level in a non-polar material includes an electrical circuit including a capacitive sensor, and a signal generator electrically connected to the capacitive sensor, the signal generator being configured to, during operation, generate and provide to the electrical circuit an electrical input of varying frequency. The system also includes a computing device communicatively coupled to the peak detector and the signal generator. The computing device is configured to, during operation, determine the moisture level in the non-polar material based on a relationship between the moisture level, and a response of the electrical circuit to the electrical input while the capacitive sensor is in contact with the non-polar material.

In another aspect of the disclosed technology, the electrical circuit further includes a peak detector configured to, during operation, determine a peak output voltage of the electrical circuit in response to the electrical input.

In another aspect of the disclosed technology, the computing device is further configured to, during operation, determine a capacitance of the capacitive sensor based on the peak output voltage of the electrical circuit; and the relationship between the moisture level, and a response of the electrical circuit to the electrical input while the capacitive sensor is in contact with the non-polar material is a relationship between the moisture level, and a change in the capacitance of the capacitive sensor in response to a variation in the frequency of the electrical input to the capacitive sensor.

In another aspect of the disclosed technology, the computing device is further configured to correlate the moisture level with the change in the capacitance of the capacitive sensor in response to the variation in the frequency of the electrical input to the capacitive sensor.

In another aspect of the disclosed technology, substantially all of the change in the capacitance of the capacitive sensor in response to the variation in the frequency of the electrical input is due moisture present in the non-polar material.

In another aspect of the disclosed technology, the change in the capacitance of the capacitive sensor in response to the variation in the frequency of the electrical input is substantially unaffected by the presence of the non-polar material.

In another aspect of the disclosed technology, the variation in the frequency of the electrical input is a variation in the frequency of the electrical input between about 50 kHz and about 450 kHz.

In another aspect of the disclosed technology, the non-polar material is a polymeric material. In another aspect of the disclosed technology, the signal generator is a radiofrequency signal generator.

In another aspect of the disclosed technology, the computing device is further configured to, during operation, determine a minimum moisture level in the non-polar material based on the relationship between the moisture level, and the response of the electrical circuit to the electrical input while the capacitive sensor is in contact with the non-polar material, the minimum moisture level being about 25 parts per million to about 100 parts per million.

In another aspect of the disclosed technology, the electrical circuit further includes a resistor electrically connected to the signal generator and the capacitive sensor.

In another aspect of the disclosed technology, the computing device is further configured to, during operation, determine the moisture level in the non-polar material after the capacitive sensor has been in contact with the non-polar material for about ten seconds.

In another aspect of the disclosed technology, an inflow rate of the non-polar material to the capacitive sensor is about 18 cubic centimeters per second, and an outflow rate of the non-polar material from the capacitive sensor is about 18 cubic centimeters per second.

In another aspect of the disclosed technology, the non-polar material is a first type of nonpolar material; and the first computing device is further configured to determine the moisture level in a second type of non-polar material based on the relationship between the moisture level, and the response of the electrical circuit to the electrical input for the first type of nonpolar material.

In another aspect of the disclosed technology, a method for determining the moisture level in a non-polar material includes providing an electrical circuit including a capacitive sensor; providing an electrical input of varying frequency to the electrical circuit while the capacitive sensor is in contact with the non-polar material; determining a response of the electrical circuit to the electrical input; and determining the moisture level in the non-polar material based on a relationship between the moisture level, and the response of the electrical circuit to the electrical input.

In another aspect of the disclosed technology, determining a response of the electrical circuit to the electrical input includes measuring a peak output voltage of the electrical circuit in response to the electrical input.

In another aspect of the disclosed technology, the method further includes determining a capacitance of the capacitive sensor based on the peak output voltage of the electrical circuit; and determining the moisture level in the non-polar material based on a relationship between the moisture level, and the response of the electrical circuit to the electrical input includes determining the moisture level in the non-polar material based on a relationship between the moisture level, and a change in the capacitance of the capacitive sensor in response to the variation in the frequency of the electrical input to the electrical circuit.

In another aspect of the disclosed technology, determining the moisture level in the nonpolar material based on a relationship between the moisture level, and a change in the capacitance of the capacitive sensor in response to the variation in the frequency of the electrical input to the electrical circuit includes correlating the moisture level with the change in the capacitance of the capacitive sensor in response to the variation in the frequency of the electrical input to the electrical circuit.

In another aspect of the disclosed technology, providing an electrical circuit including a capacitive sensor further includes providing an electrical circuit including the capacitive sensor and a peak detector; and determining a response of the electrical circuit to the electrical input includes measuring the peak output voltage using the peak detector.

In another aspect of the disclosed technology, providing an electrical circuit including a capacitive sensor further includes providing an electrical circuit including the capacitive sensor and a radiofrequency generator; and providing an electrical input of varying frequency to the electrical circuit while the capacitive sensor is in contact with the non-polar material includes providing the electrical input of varying frequency to the electrical circuit using the radiofrequency generator.

In another aspect of the disclosed technology, substantially all of the change in the capacitance of the capacitive sensor in response to the variation in the frequency of the electrical input is due moisture present in the non-polar material.

In another aspect of the disclosed technology, the change in the capacitance of the capacitive sensor in response to the variation in the frequency of the electrical input is substantially unaffected by the presence of the non-polar material.

In another aspect of the disclosed technology, the non-polar material is a polymeric material.

In another aspect of the disclosed technology, the non-polar material is a first type of nonpolar material: and the method further includes determining the moisture level in a second type of non-polar material based on the relationship between the moisture level, and the response of the electrical circuit to the electrical input for the first type of non-polar material.

### DESCRIPTION OF THE DRAWINGS

The patent or application file contains at least one drawing executed in color. Copies of this patent or patent application publication with color drawing(s) will be provided by the Office upon request and payment of the necessary fee.

The following drawings are illustrative of particular embodiments of the present disclosure and therefore do not limit the scope of the present disclosure. The drawings are not to scale and are intended for use in conjunction with the explanations in the following detailed description.

FIG. 1A is a graphical representation of the variation in the real part of the dielectric constant of a polyamide material with variations in the input-voltage frequency, for three different moisture levels in the material.

FIG. 1B is a graphical representation of the variation in the loss tangent of the polyamide material with variations in the input-voltage frequency, for three different moisture levels in the material.

FIG. 2 is a graphical representation of the variation in the permittivity (ε′) of a capacitor containing a dielectric material in response to variations in the frequency of the input voltage to the capacitor.

FIG. 3 is a diagrammatic representation of a system for determining the moisture level in a non-polar material.

FIG. 4 is a perspective view of the system shown in FIG. 3.

FIG. 5 is a perspective view of a capacitance probe of the system shown in FIGS. 3 and 4.

FIG. 6 is a perspective view of electronic circuitry and a microcontroller of the system shown in FIGS. 3-5.

FIG. 7 is a schematic depiction of the electronic circuitry of the system shown in FIGS. 3-6.

FIG. 8A is a graphical representation of the change in capacitance of the capacitance probe of the system shown in FIGS. 3-7, as the frequency of an input voltage to the probe is varied.

FIG. 8B is a graphical representation of the relationship between the moisture level in plastic pellets in contact with the capacitance probe of the system shown in FIGS. 3-7, and corresponding changes in the capacitance of the capacitance probe as the frequency of the input voltage to the probe is varied.

### DETAILED DESCRIPTION

The inventive concepts are described in relation to the attached figures, in which reference numerals represent parts and assemblies throughout the several views. The figures are not drawn to scale and are provided merely to illustrate the instant inventive concepts. The figures do not limit the scope of the present disclosure or the appended claims. Several aspects of the innovative concepts are described below with reference to example applications for illustrative purposes. Specific details, relationships, and methods are set forth herein to provide a complete understanding of the inventive concepts. However, one having ordinary skill in the relevant art will readily recognize that innovative concepts can be practiced without specific details or with other methods. In other instances, well-known structures or operations are not shown in detail to avoid obscuring the inventive concepts.

The dielectric properties of any material depend on the atomic structure, composition, and other properties of the material. Dielectric materials are characterized into two types, polar and nonpolar, based on their electrical properties. The permittivity of a capacitor containing a polar dielectric is affected significantly by the frequency of the input voltage provided to the capacitor. Conversely, the permittivity a capacitor containing a non-polar dielectric is not affected significantly by the frequency of the input voltage.

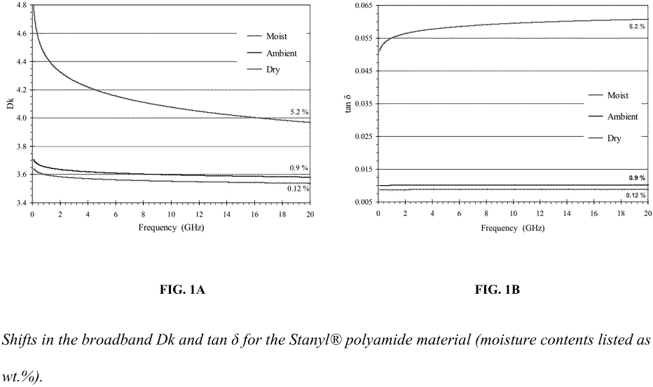

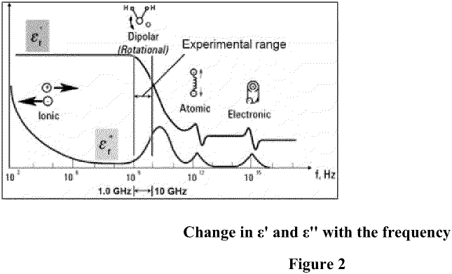

The variation in the permittivity (ε′) of capacitor containing a dielectric material in response to variations in the input-voltage frequency is depicted in FIG. 2. As can be seen in FIG. 2, permittivity (ε) decreases as the input-voltage frequency is increased from about 10 kHz to about 1000 MHz (1 GHz). Because capacitance is proportional to permittivity, the variation of capacitance with input-voltage frequency is similar the variation in permittivity as shown in FIGS. 1, i.e., the capacitance decreases as the input-voltage frequency is increased from about 1 kHz to about 1 GHz. The proportional relationship between the change in capacitance and change in permittivity can be represented by the following equation:1

$$\left({\text{C}}_{\text{f1}} - {\text{C}}_{\text{f2}}\right) \text{α} \left({\text{ε}}_{\text{f1}} \text{-} {\text{ε}}_{\text{f2}}\right) ,$$

where C_{f1} is the capacitance of the capacitor at a first input-voltage frequency; C_{f2} is the capacitance at a second input-voltage frequency; ε_{f1} is the permittivity of the capacitor at the first input-voltage frequency; and ε_{f2} is the permittivity at the second input-voltage frequency

Because water is a polar dielectric, a non-polar material with a moisture content has both polar and non-polar components. For a mixture of polar and non-polar materials, the net relative permittivity can be given as:

$${\text{ε}}_{\text{net}} = {\text{ε}}_{\text{polar}} + {\text{ε}}_{\text{non-polar}} ,$$

where εₚₒₗₐᵣ and εₙₒₙ₋ₚₒₗₐᵣ are the polar and non-polar dielectric materials, respectively. Thus, when a non-polar material with moisture content is used as a dielectric material for a capacitor, the overall capacitance decreases as the frequency of the input voltage to the capacitor is increased. The change in capacitance also varies with the amount of moisture present in the material. (R. Moura Dos Santos et al., “High Precision Capacitive Moisture Sensor for Polymers: Modelling and Experiments,” IEEE Sensors Journal, vol. 20, no. 6, pp. 3032-3039, Mar. 15, 2020, doi: 10.1109/JSEN.2019.2957108.) Based on this principle, the overall moisture content in the material can be estimated independent of the type of non-polar material in the capacitor, because the permittivity of the non-polar material does not change significantly with changes in the frequency of the input voltage.

### Moisture Measurement System

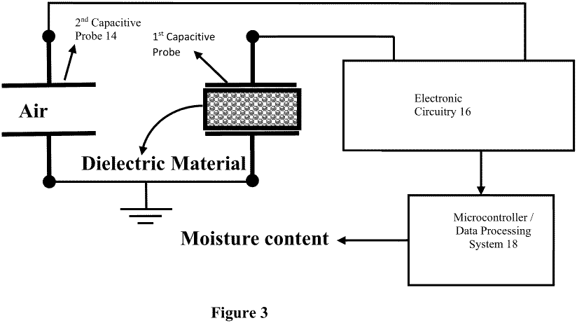

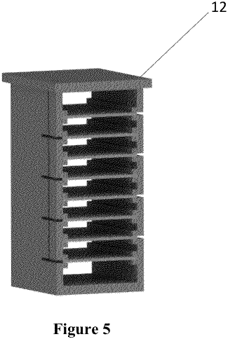

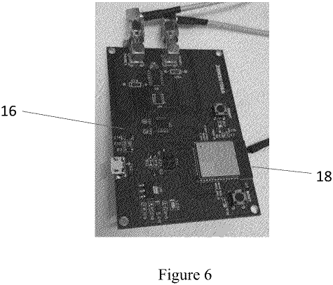

FIGS. 3-7 depict a system 10 for measuring the moisture concentration, or moisture level, in a non-polar bulk material, such as pellets of plastic resin. Referring to FIG. 3, the system 10 comprises a first capacitance probe 12; a second capacitance probe 14; electronic circuitry in the form of an electrical circuit 16; and a computing device in the form of, for example, a microcontroller 18. The use of the microcontroller 18 as the computing device is disclosed for illustrative purposes only. Other types of computing devices, such as a minicomputer, a microcomputer, a desktop computer, a notebook computer, etc., can be used as the computing device in alternative embodiments. Also, the use of the system 10, and the method for measuring moisture concentration disclosed herein, to measure the moisture concentration in pellets of plastic resin are disclosed for illustrative purposes only. The system 10 and method can be used to determine the moisture concentration in other types of polymeric materials, and in other types of non-polar materials.

### Capacitive Probes

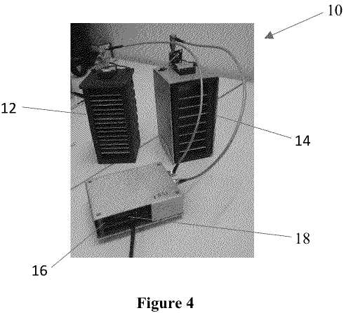

The first capacitance probe 12 is used to determine the moisture level in non-polar materials. In the embodiment disclosed herein, first capacitance probe 12 is used to determine the moisture level in pellets of raw plastic resin as the pellets undergo a drying process in a dryer. The first capacitance probe 12 can be parallel-plate capacitor, as shown in FIG. 4. In alternative embodiments, a capacitance array probe, i.e., a parallel combination of several parallel-plate capacitors, can be used in lieu of the first capacitance probe 12, to achieve a higher sensitivity in the moisture-content measurement. The first capacitance probe 12 can have other configurations in other alternative embodiments.

The first capacitance probe 12 can be configured as follows:
length of the plates: about 6 cm;
width of the plates: about 4 cm;
thickness of the plates: about 1.6 mm;
gap between the plates: about 1 cm;
total number of plates: about 8.

The above characteristics of the first capacitance probe 12 are presented for illustrative purposes only. Alternative embodiments of the first capacitance probe 12 can have other dimensions, and can be configured with more, or less than eight plates.

The second capacitance probe 14 is substantially identical to the first capacitance probe 12. The second capacitance probe 14 is placed at room condition, i.e., is exposed to the ambient environment around the dryer, to compensate for the effect of moisture in the air, and to eliminate the effect of drift on the measurement results. Alternative embodiments of the system 10 can forgo the use of the second probe 14; however, the elimination of the second probe 14 can make it difficult or unfeasible to remove the effects of moisture present in the ambient air from the moisture measurement.

The first capacitive probe 12 is configured so that the non-polar material can pass through the first capacitive probe 12. An inflow rate of the non-polar material to the first capacitive probe 12 is about 18 cubic centimeters per second, and an outflow rate of the non-polar material from the first capacitive probe 12 is about 18 cubic centimeters per second.

### Electronic Circuitry / Computing Device

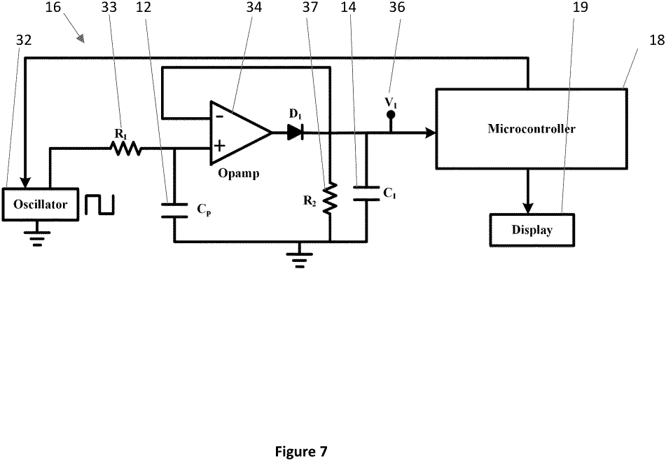

Referring to FIG. 7, the electrical circuit 16 is configured as an RC circuit. The electrical circuit 16 includes the first and second capacitance probes 12, which are arranged in parallel and function as the capacitors in the electrical circuit 16. The electrical circuit 16 further includes an oscillating signal source in the form of a radiofrequency (RF) signal generator 32 electrically connected to a first side of the first capacitance probe 12 by way of a first resistor 33. The RF signal generator 32 is configured to act as a voltage source for the first capacitance probe 12. The RF signal generator 32 generates an input voltage for the first capacitance probe 12 in the form of a square wave. The frequency of the square wave is based on an input provided to the RF signal generator 32 by the microcontroller 18.

The electrical circuit 16 also includes an operational amplifier 34. The non-inverting input terminal of the operational amplifier 34 is electrically connected to the first capacitance probe 12 by way of the first resistor 33. The inverting input terminal of the operational amplifier 34 is electrically connected to a second side of the first capacitance probe 12 and a second side of the second capacitance probe 14 by way of the second resistor 37. The output of the operational amplifier 34 is electrically connected to the microcontroller 18.

The electrical circuit 16 also includes a modified peak detector 36 electrically connected to the output of the operational amplifier 34 and the microcontroller 18. (The peak detector 36 is modified by the addition of a limiting circuit, as known to those skilled in the art of electrical circuit design.) During operation of the system 10, the square wave generated by the RF signal generator 32 is provided to the first capacitive probe 12. The peak detector 36 determines the response of the electrical circuit 16 to the input provided by the RF signal generator 36 by measuring the peak output voltage (V₁) of the RC circuit, as amplified by the operational amplifier 34. The microcontroller 18 is configured to calculate the capacitance (Cₚ) of the first capacitance probe 12 based on the value of V₁, and the following relationship:

$${\text{C}}_{\text{p}} = \frac{1}{2 ∗ {R}_{1} ∗ f ∗ ln \left(\frac{V 1}{3.3 - \left(V 1\right)}\right)} ,$$

where f is the frequency of the input square wave, and V₁ is the output value of the peak detector 36.

The use of the peak detector to determine the response of the electrical circuit 16 to the input provided by the RF signal generator 36 is disclosed for illustrative purposes only. The response of the electrical circuit 16 can be determined using other types of devices in alternative embodiments.

### Measurement of the Moisture Level

Prior to activation of the system 10, the first capacitance probe 12 is immersed in the pellets of raw plastic material that have been placed in the dryer, so that some of the pellets become disposed between the plates of the first capacitance probe 12. The pellets act as a dielectric material, which affects the capacitance of the first capacitance probe 12.

During the drying process, and upon activation of the system 10, the RF signal generator 32, in response to inputs from the microcontroller 18, generates and sends an input signal to the first side of the first capacitance probe 12. The input signal varies in frequency from, for example, about 50 kHz to about 450 kHz. The peak detector 34 determines the response of the electrical circuit 16 to the input signal by continually measuring the peak value (V₁) of the resulting voltage differential between the first and second sides of the first capacitive probe 12, as amplified by the operational amplifier 34. The use of an input-frequency range of about 50 kHz and 450 kHz is disclosed for illustrative purposes only. The input signal can have other frequencies within, and outside of the radiofrequency range in alternative embodiments.

The microcontroller 18 calculates the capacitance of the first capacitance probe 12 based on the value of V₁ in the above-discussed manner. The microcontroller 18 also calculates the change in the capacitance of the first capacitance probe 12 between the beginning and end of the frequency sweep, i.e., the microcontroller 18 calculates the difference between the capacitance values obtained at 50 kHz and 450 kHz. The microcontroller 18 then multiplies the difference by a correlation corrective formula to negate the effect of circuit capacitance. The system 10 repeats this process at predetermined intervals of time throughout the drying process. For example, the microcontroller 18 can be configured to initiate a capacitance scan about every one to ten seconds, until the resulting moisture reading reaches a predetermined value indicating that the plastic pellets have reached a suitable level of dryness.

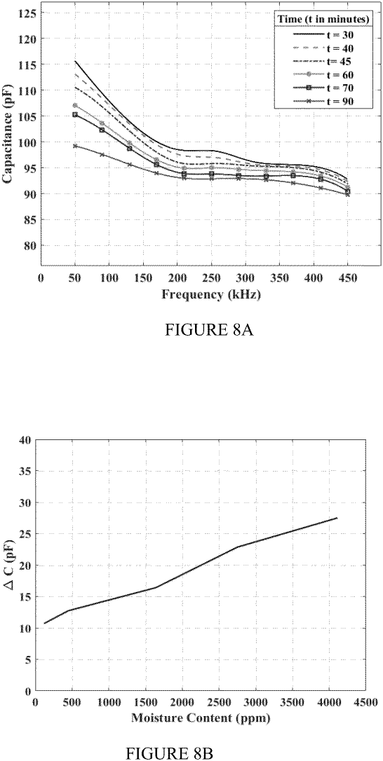

FIG. 8A depicts, in graphical form, an illustrative example of the change in capacitance of the first capacitance probe 12, with the plastic pellets disposed between its plates, as the input-voltage frequency is varied between about 50 kHz and about 450 kHz, for six different moisture levels, i.e., at six different times in the drying process. As can be seen in FIG. 8A, the capacitance decreases as the input-voltage frequency is increased. FIG. 8A also shows that, at the lower frequencies, the rate of change in the capacitance also decreases with time, i.e., with the moisture content in the pellets.

### Correlating the Capacitance Data With Moisture Content

The microcontroller 18 correlates the change in capacitance of the first capacitance probe 12 across the above-noted range of input signal frequencies, with the moisture content in the plastic pellets. The correlation is based on a predetermined relationship between the change in capacitance and the moisture content. This relationship can be determined by measuring the moisture content in a batch of raw plastic pellets using a conventional moisture-measurement technique such as one of the techniques discussed above, e.g., using chemical titration with Karl Fischer reagents. On a simultaneous basis, the system 10 determines the change in capacitance of the first capacitive probe 14, which is immersed in the plastic pellets, as the frequency of its input signal is varied between as discussed above. This process can be repeated as the pellets dry, i.e., as the moisture content of the pellets decreases over time.

The resulting data set can be processed using a curve fit or other mathematical technique to develop a mathematical relationship between the as-measured moisture content, and the corresponding changes in capacitance of the first capacitance probe 12 as measured by the system 10. FIG. 8B depicts, in graphical form, an illustrative example showing the relationship between the moisture content in the plastic pellets, and the corresponding changes in capacitance of the first capacitance probe 12 as the input-voltage frequency is varied between about 50 kHz and about 450 kHz. As can be seen in FIG. 8B, the change in capacitance increases with increasing moisture content.

The relationship between moisture content and the change in capacitance can be stored in the memory of the microcontroller 18, or another computing device such as an edge-cloud server located remotely from the dryer, so that the microcontroller 18 or other computing device, during operation of the system 10, can estimate the moisture level in the plastic pellets at any point in the drying process, based on the measured changes in the capacitance of the first capacitance probe 12 as the frequency of its input signal is varied between, for example, 50 kHz and 450 kHz. The system 10 can determine the moisture relatively quickly, for example, after the capacitive probe 12 has been energized and exposed to the plastic pellets for about ten seconds. Also, the system 10 can be calibrated to determine a minimum moisture level between, for example, about 25 parts per million (ppm) and about 100 ppm.

The moisture level can be displayed to the user on a display 19, depicted in FIG. 7. Also, the estimated moisture level can be transmitted to the process controller of the dryer in which the plastic pellets are being dried. The process controller can be configured to end the drying process when the moisture level reaches a predetermined value indicating that the pellets have reached a sufficient level of dryness.

As discussed above, any changes in the capacitance of the first capacitance probe 12 resulting from the presence of the non-polar plastic material are negligible. Thus, the pre-determined relationship between the moisture content and the corresponding changes in the capacitance of the first capacitance probe 12 applies regardless of the type of plastic material being dried. The system 10, therefore, does not require any type of recalibration, reprogramming, or other type of reconfiguration when used to measure the moisture content of different types of plastic materials. Because recalibration of a conventional moisture-sensing system typically is a time-consuming process, the system 10 can facilitate more efficient use of the dryer with different types of plastic materials.

The features and functions described above, as well as alternatives, may be combined into many other different systems or applications. Various alternatives, modifications, variations or improvements may be made by those skilled in the art, each of which is also intended to be encompassed by the disclosed embodiments.

We claim:

1. A system for determining low bulk moisture content in a first and a second type of non-polar material without a need to recalibrate the system, comprising:
an electrical circuit comprising: a capacitive sensor; and a signal generator electrically connected to the capacitive sensor, the signal generator being configured to, during operation, generate and provide to the electrical circuit an electrical input of varying frequency; and
a computing device communicatively coupled to the peak detector and the signal generator, wherein the computing device is configured to, during operation, determine the moisture level in the first and second types of non-polar materials based on a relationship between the moisture level, and a frequency response of the electrical circuit to the electrical input while the capacitive sensor is in contact with the first or the second types of non-polar material, wherein substantially all of the frequency response of the electrical circuit to the electrical input is due moisture present in the non-polar material.

2. A system for determining the moisture level in a non-polar material, comprising:
an electrical circuit comprising: a capacitive sensor; and a signal generator electrically connected to the capacitive sensor, the signal generator being configured to, during operation, generate and provide to the electrical circuit an electrical input of varying frequency; and
a computing device communicatively coupled to the peak detector and the signal generator, wherein the computing device is configured to, during operation, determine the moisture level in the non-polar material based on a relationship between the moisture level, and a response of the electrical circuit to the electrical input while the capacitive sensor is in contact with the non-polar material.

3. The system of claim 2, wherein the electrical circuit further comprises a peak detector configured to, during operation, determine a peak output voltage of the electrical circuit in response to the electrical input.

4. The system of claim 2, wherein:
the computing device is further configured to, during operation, determine a capacitance of the capacitive sensor based on the peak output voltage of the electrical circuit; and
the relationship between the moisture level, and a response of the electrical circuit to the electrical input while the capacitive sensor is in contact with the non-polar material is a relationship between the moisture level, and a change in the capacitance of the capacitive sensor in response to a variation in the frequency of the electrical input to the capacitive sensor.

5. The system of claim 4, wherein the computing device is further configured to correlate the moisture level with the change in the capacitance of the capacitive sensor in response to the variation in the frequency of the electrical input to the capacitive sensor.

6. The system of claim 4, wherein substantially all of the change in the capacitance of the capacitive sensor in response to the variation in the frequency of the electrical input is due moisture present in the non-polar material.

7. The system of claim 4, wherein the change in the capacitance of the capacitive sensor in response to the variation in the frequency of the electrical input is substantially unaffected by the presence of the non-polar material.

8. The system of claim 2, wherein the variation in the frequency of the electrical input is a variation in the frequency of the electrical input between about 50 kHz and about 450 kHz.

9. The system of claim 2, wherein the non-polar material is a polymeric material.

10. The system of claim 2, wherein the signal generator is a radiofrequency signal generator.

11. The system of claim 2, wherein the computing device is further configured to, during operation, determine a minimum moisture level in the non-polar material based on the relationship between the moisture level, and the response of the electrical circuit to the electrical input while the capacitive sensor is in contact with the non-polar material, the minimum moisture level being about 25 parts per million to about 100 parts per million.

12. The system of claim 2, wherein the electrical circuit further comprises a resistor electrically connected to the signal generator and the capacitive sensor.

13. The system of claim 2, wherein the computing device is further configured to, during operation, determine the moisture level in the non-polar material after the capacitive sensor has been in contact with the non-polar material for about ten seconds.

14. The system of claim 2, wherein an inflow rate of the non-polar material to the capacitive sensor is about 18 cubic centimeters per second, and an outflow rate of the non-polar material from the capacitive sensor is about 18 cubic centimeters per second.

15. The system of claim 2, wherein the non-polar material is a first type of non-polar material; and the first computing device is further configured to determine the moisture level in a second type of non-polar material based on the relationship between the moisture level, and the response of the electrical circuit to the electrical input for the first type of nonpolar material.

16. A method for determining the moisture level in a non-polar material, comprising:
providing an electrical circuit comprising a capacitive sensor;
providing an electrical input of varying frequency to the electrical circuit while the capacitive sensor is in contact with the non-polar material;
determining a response of the electrical circuit to the electrical input; and
determining the moisture level in the non-polar material based on a relationship between the moisture level, and the response of the electrical circuit to the electrical input.

17. The method of claim 16, wherein determining a response of the electrical circuit to the electrical input comprises measuring a peak output voltage of the electrical circuit in response to the electrical input.

18. The method of claim 17, further comprising determining a capacitance of the capacitive sensor based on the peak output voltage of the electrical circuit; wherein determining the moisture level in the non-polar material based on a relationship between the moisture level, and the response of the electrical circuit to the electrical input comprises determining the moisture level in the non-polar material based on a relationship between the moisture level, and a change in the capacitance of the capacitive sensor in response to the variation in the frequency of the electrical input to the electrical circuit.

19. The method of claim 18, wherein determining the moisture level in the non-polar material based on a relationship between the moisture level, and a change in the capacitance of the capacitive sensor in response to the variation in the frequency of the electrical input to the electrical circuit comprises correlating the moisture level with the change in the capacitance of the capacitive sensor in response to the variation in the frequency of the electrical input to the electrical circuit.

20. The method of claim 17, wherein:
providing an electrical circuit comprising a capacitive sensor further comprises providing an electrical circuit comprising the capacitive sensor and a peak detector; and
determining a response of the electrical circuit to the electrical input comprises measuring the peak output voltage using the peak detector.

21. The method of claim 16, wherein:
providing an electrical circuit comprising a capacitive sensor further comprises providing an electrical circuit comprising the capacitive sensor and a radiofrequency generator; and
providing an electrical input of varying frequency to the electrical circuit while the capacitive sensor is in contact with the non-polar material comprises providing the electrical input of varying frequency to the electrical circuit using the radiofrequency generator.

22. The method of claim 18, wherein substantially all of the change in the capacitance of the capacitive sensor in response to the variation in the frequency of the electrical input is due moisture present in the non-polar material.

23. The system of claim 18, wherein the change in the capacitance of the capacitive sensor in response to the variation in the frequency of the electrical input is substantially unaffected by the presence of the non-polar material.

24. The method of claim 16, wherein the non-polar material is a polymeric material.

25. The method of claim 16, wherein the non-polar material is a first type of non-polar material: and further comprising determining the moisture level in a second type of non-polar material based on the relationship between the moisture level, and the response of the electrical circuit to the electrical input for the first type of non-polar material.
